(19) United States
(12) Patent Application Publication
(10) Pub. No.: US 2022/0023969 A1
(43) Pub. Date: Jan. 27, 2022

(54) METHOD FOR LASER MARKING A METALLIC SURFACE

(71) Applicant: Huf Technologies GmbH, Velbert (DE)

(72) Inventors: Mansour Ashtiani, Novi, MI (US); Patrick Christopher McGehee, Commerce Township, MI (US); Geoffrey Corbin, Grosse Pointe Farms, MI (US); Jeric Frank Foster, Chesaning, MI (US); Volker Poppinga, Cologne (DE)

(21) Appl. No.: 16/935,762

(22) Filed: Jul. 22, 2020

(51) Int. Cl. B23K 26/18; B23K 26/122; B23K 26/12; B23K 26/16

(52) U.S. Cl. CPC B23K 26/18; B23K 26/16; B23K 26/123; B23K 26/122

(57) ABSTRACT

A method for marking a location on a surface of a component includes irradiating the location with a first laser beam to create a first mark having a first color. The location defines a normal extending perpendicularly therefrom. The first laser beam is disposed at a first angle relative to the normal. The method also includes irradiating the location with a second laser beam to create a second mark having a second color different than the first color. The second laser beam is disposed at a second angle relative to the normal. The second angle is different than the first angle.

### FIELD

The present disclosure relates generally to a method for marking a surface of an object, and more particularly to a method for coloring a metallic surface of an object by applying a laser to the metallic surface.

### BACKGROUND

This section provides background information related to the present disclosure and is not necessarily prior art.

The outer surface of a part or component can be marked or colored using various methods and techniques. For example, the outer surface of a plastic part or component can be marked or colored by painting, molding with a coloring agent, printing, or irradiating with a laser. Similarly, the outer surface of a metal part, or the metallic outer surface of a part formed from a material other than metal, can be marked or colored by painting, printing, or irradiating with a laser. For example, U.S. Publication No. 2008/0139707 A1 describes a method for producing a multi-color laser marking on a molded article, while U.S. Pat. No. 6,313,436 describes a method for laser-marking the surface of a material by applying a coating to the surface and then irradiating the coating with a laser. While known methods for marking or coloring metallic surfaces of various components have proven acceptable for their intended purposes, a continuous need for improvement remains in the pertinent art.

### SUMMARY

This section provides a general summary of the disclosure, and is not a comprehensive disclosure of its full scope or all of its features.

One aspect of the disclosure provides a method for marking a location on a surface of a component. The location may define a normal extending perpendicularly from the location. The method may include covering the surface of the component with a first medium. The method may also include irradiating the location with a first laser beam through the first medium to create a first mark having a first color. The method may also include removing the first medium from the surface of the component.

Implementations of the disclosure may include one or more of the following optional features. In some implementations, the first medium includes at least one of de-ionized water, tap water, distilled water, or a mixture of water and at least one of a salt or a colorant. The first medium may be in a vaporized form defining a humidity between ninety percent and ninety-nine percent.

In some implementations, the first medium defines a depth between one hundred and two hundred micrometers.

In some implementations, the method further includes irradiating the location with a second laser beam to create a second mark having a second color different than the first color prior to removing the first medium from the surface of the component. The first laser beam may be disposed at a first angle relative to the normal. The second laser beam may be disposed at a second angle relative to the normal. The second angle may be different than the first angle. The first angle may be greater than the second angle. The first angle may be less than the second angle.

In some implementations, the method also includes plasma treating the surface of the component prior to covering the surface of the component with the first medium. The method may also include cleaning the surface of the component with de-ionized water after irradiating the location with the first laser beam. The method may also include drying the component.

In some implementations, the first laser beam is generated by a laser source. The method may also include moving one of the component or the laser source relative to another of the component or the laser source while irradiating the location with the first laser beam. The method may also include moving one of the component or the laser source relative to the other of the component or the laser source while irradiating the location with the second laser beam.

In some implementations, the first color includes a shade of gray or a shade of brown, and the second color includes a shade of blue.

In some implementations, the method includes defocusing the first laser beam.

In some implementations, the method includes removing a residue from the second mark. Removing the residue from the second mark may include applying alcohol or water to the surface.

In some implementations, the surface is formed at least in part from chrome.

In some implementations, the method also includes covering the surface with a second medium. The second medium may include ambient air.

Another aspect of the disclosure provides a method of laser marking. The method may include providing a component comprising an outer surface including a location having a first color. The method may also include covering the outer surface with a first medium. The method may further include irradiating the location through the first medium with a first laser beam to change the first color of the location to a second color. The method may also include removing the component from the first medium.

This aspect may include one or more of the following optional features. In some implementations, the first medium includes at least one of de-ionized water, tap water, distilled water, or a mixture of water and at least one of a salt or a colorant. The first medium may be in a vaporized form defining a humidity between ninety percent and ninety-nine percent. The first medium may define a depth between one hundred and two hundred micrometers.

In some implementations, the method also includes irradiating the location with a second laser beam to change the second color of the location to a third color prior to removing the first medium from the surface of the component. The first laser beam may be disposed at a first angle relative to a normal extending from the location. The second laser beam may be disposed at a second angle relative to the normal. The second angle may be different than the first angle. The first angle may be greater than the second angle. The first angle may be less than the second angle.

In some implementations, the method also includes plasma treating the surface of the component prior to covering the surface of the component with the first medium. The method may also include cleaning the surface of the component with de-ionized water after irradiating the location with the first laser beam. The method may also include drying the component.

In some implementations, the first laser beam is generated by a laser source. The method may also include moving one of the component or the laser source relative to another of the component or the laser source while irradiating the location with the first laser beam. The method may also include moving one of the component or the laser source relative to the other of the component or the laser source while irradiating the location with the second laser beam. The second color may include a shade of gray or a shade of brown. The third color may include a shade of blue.

In some implementations, the method also includes defocusing the first laser beam.

In some implementations, the method also includes removing a residue from the location. Removing the residue from the location may include applying alcohol or water to the outer surface.

In some implementations, the outer surface is formed at least in part from chrome.

In some implementations, the method also includes covering the outer surface with a second medium. The second medium may include ambient air.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a schematic cross-sectional view of a component suitable for laser marking in accordance with the principles of the present disclosure;

FIG. 2 is a flowchart illustrating a method for marking a surface of a component in accordance with the principles of the present disclosure;

FIG. 3A is a schematic perspective view of a laser marking system in a first stage of operation in accordance with the principles of the present disclosure;

FIG. 3B is a schematic perspective view of the laser marking system of FIG. 3A in a second stage of operation in accordance with the principles of the present disclosure;

FIG. 3C is a schematic perspective view of the laser marking system of FIG. 3A in a third stage of operation in accordance with the principles of the present disclosure;

FIG. 4A is a schematic cross-sectional view of the laser marking system of FIG. 3A taken along the line 4A-4A;

FIG. 4B is a schematic cross-sectional view of the laser marking system of FIG. 3B taken along the line 4B-4B;

FIG. 5 is a flowchart illustrating another method for marking a surface of a component in accordance with the principles of the present disclosure;

FIG. 6 is a schematic view of another laser marking system in accordance with the principles of the present disclosure;

FIG. 7 is a schematic view of the laser marking system of FIG. 6 in a first laser marking stage of operation; and

FIG. 8 is a schematic view of the laser marking system of FIG. 6 in a second laser marking stage of operation.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

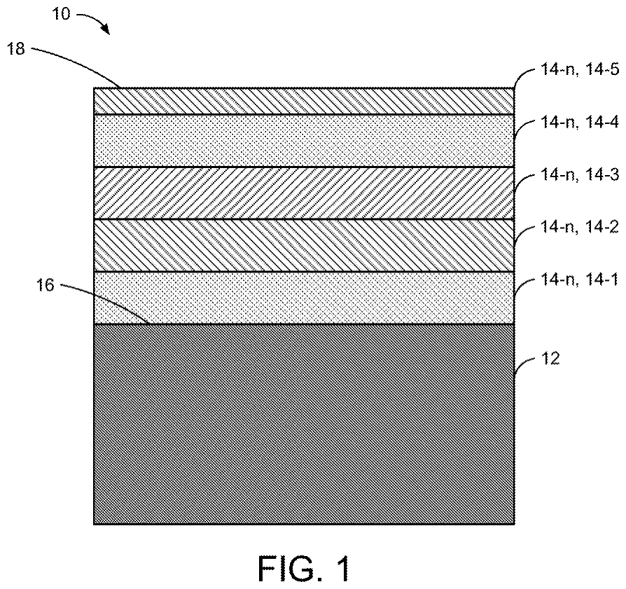

With reference to FIG. 1, a cross-sectional view of an exemplary component 10 for pulse-marking is illustrated. In some implementations, the component 10 may include an automotive door handle, an automotive trim piece, or an automotive decal. It will be appreciated, however, that the component 10 may include other types of components, including non-automotive components, within the scope of the present disclosure.

The component 10 may include a substrate 12 and one or more layers 14-1, 14-2, . . . 14-n of material. The layers 14-1, 14-2, . . . 14-n of material may be disposed on an outer surface 16 of the substrate 12, such that the component 10 includes an outermost surface 18. In particular, a first layer 14-1 of material may be directly disposed on the substrate 12, while additional layers 14-2, 14-3, . . . 14-n of material may be disposed on the first layer 14-1 of material or other ones of the additional layers 14-2, 14-3, . . . 14-n of material, such that the substrate 12 or one of the layers 14-1, 14-2, . . . 14-n includes the outermost surface 18 of the component 10. In this regard, while the component 10 is generally illustrated and described herein as including five layers 14-1, 14-2, . . . 14-n of material, such that a layer 14-5 includes the outermost surface 18, it will be appreciated that the component 10 may include more or less than five layers 14-1, 14-2, . . . 14-n of material within the scope of the present disclosure, such that the substrate 12 or one of the other layers 14-1, 14-2, . . . 14-n includes the outermost surface 18. In some implementations, one or more of the materials defining the layers 14-1, 14-2, . . . 14-n may include microporous characteristics. For example, one or more of the layers 14-1, 14-2, . . . 14-n may include a material having pores defining a diameter less than two nanometers.

In some implementations, the substrate 12 is composed of a plastic or metal substrate formed from one or more of nylon, brass, an acrylonitrile butadiene styrene (ABS), a polycarbonate/ABS composite (PC/ABS), or a zinc plate. The first layer 14-1 of material may be composed of nickel, or a nickel alloy, having a thickness of approximately 1 μm. In some implementations, the first layer 14-1 includes a microporous nickel or nickel alloy material. A second layer 14-2 of material may be disposed on the first layer 14-1 of material and composed of chromium, or a chromium alloy, having a thickness of approximately 3 μm. The third layer 14-3 of material may be disposed on the second layer 14-2 of material and composed of copper, or a copper alloy, having a thickness of approximately 20 μm. The fourth layer 14-4 may be disposed on the third layer 14-3 and composed of nickel, or a nickel alloy having a thickness of approximately 15 μm. The fifth layer 14-5 of material may be disposed on the fourth layer 14-4 of material and composed of chromium, or a chromium alloy (e.g., chromium-3 or chromium-6), having a thickness of approximately 0.5 μm. In this regard, the total thickness of the layers 14-1, 14-2, . . . 14-n of material may be approximately 40 μm.

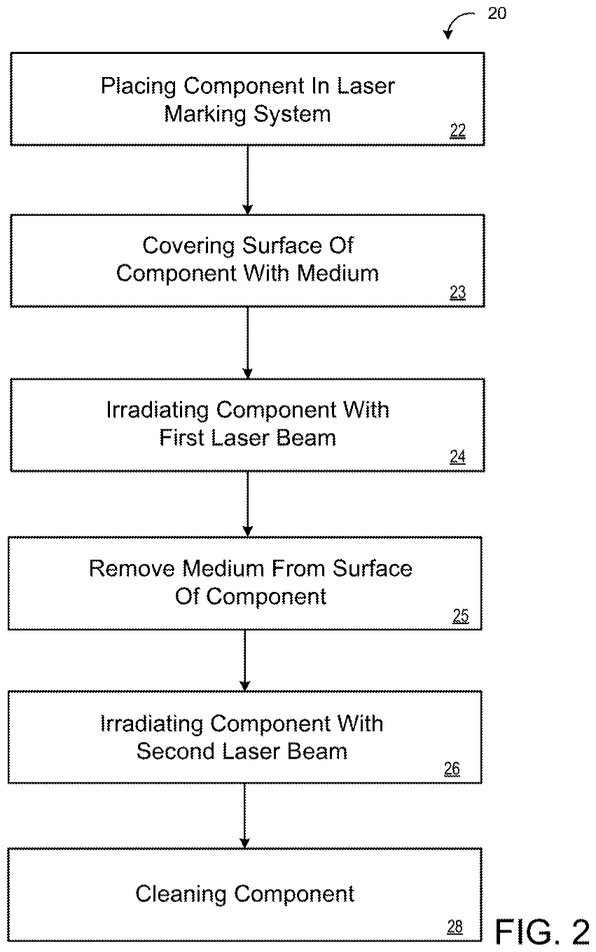

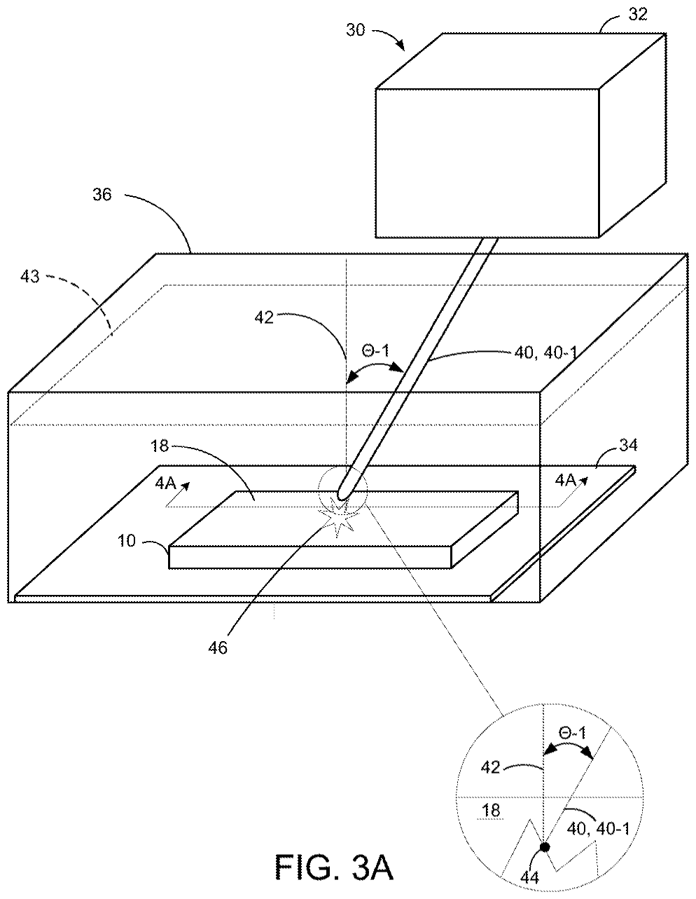

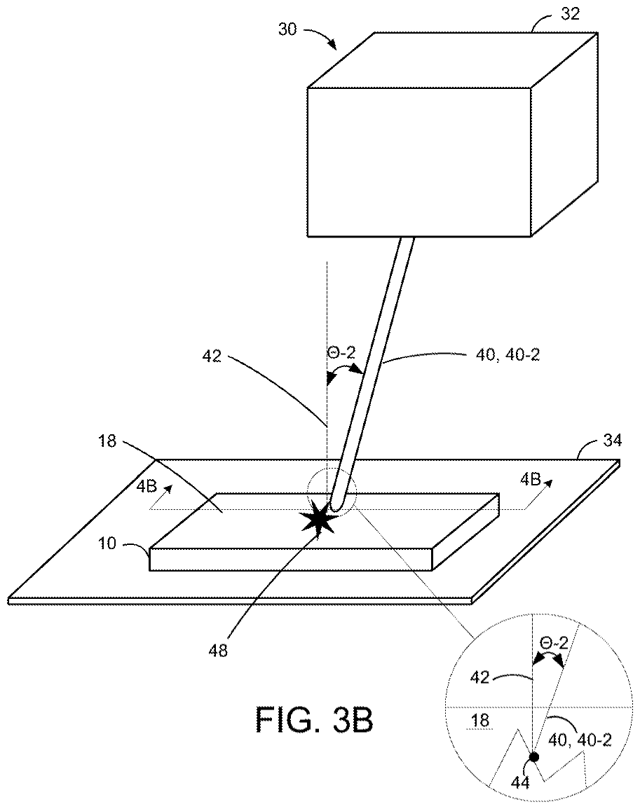

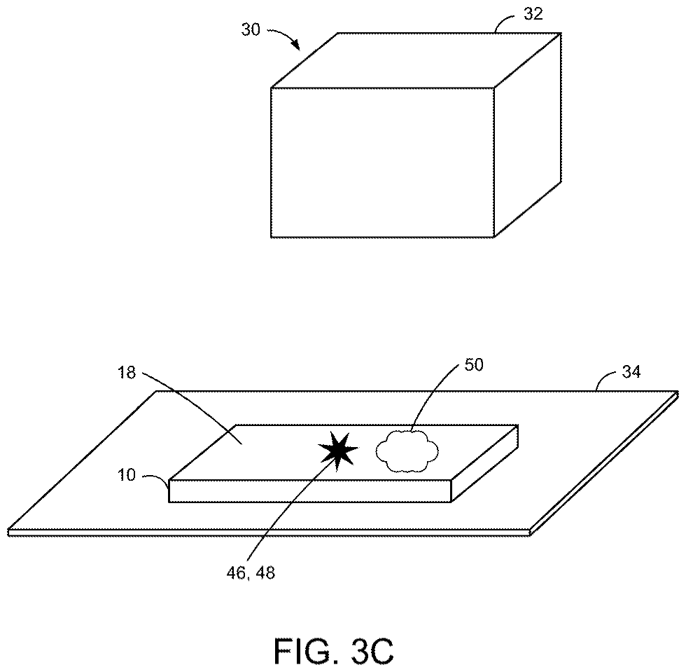

With reference to FIG. 2, a method 20 for laser-marking a component (e.g., component 10) is illustrated. As will be described, the method 20 may be implemented using a laser marking system 30 illustrated in FIGS. 3A-3C. The laser marking system 30 may include a laser source 32, a support or stage 34 to support the component 10, and a container 36. A further discussion of the component 10 and the laser source 32, including various configurations and methods of use, may be found in commonly-owned U.S. Pat. No. 9,205,697 B2, entitled “Method for Color Marking Metallic Surfaces,” which is hereby incorporated by reference in its entirety.

As will be explained in more detail below, the laser source 32 may be configured to supply or generate a laser beam 40. In this regard, the laser source 32 may be referred to herein as the laser generator 32. In particular, as will be described in more detail below, the laser source 32 may generate one or more laser beams 40, and transmit the laser beams 40 to the component 10.

As illustrated in FIG. 2, at step 22, the method 20 may include placing a component (e.g., component 10) within a laser marking system (e.g., laser marking system 30). For example, with reference to FIG. 3A, at step 22, the method 20 may include placing the component 10 on the stage 34 such that the outermost surface 18 of the component 10 is within a transmission path of a laser beam 40 of the laser source 32. In particular, the method 20 may include placing the component 10 and/or the stage 34 within the container 36.

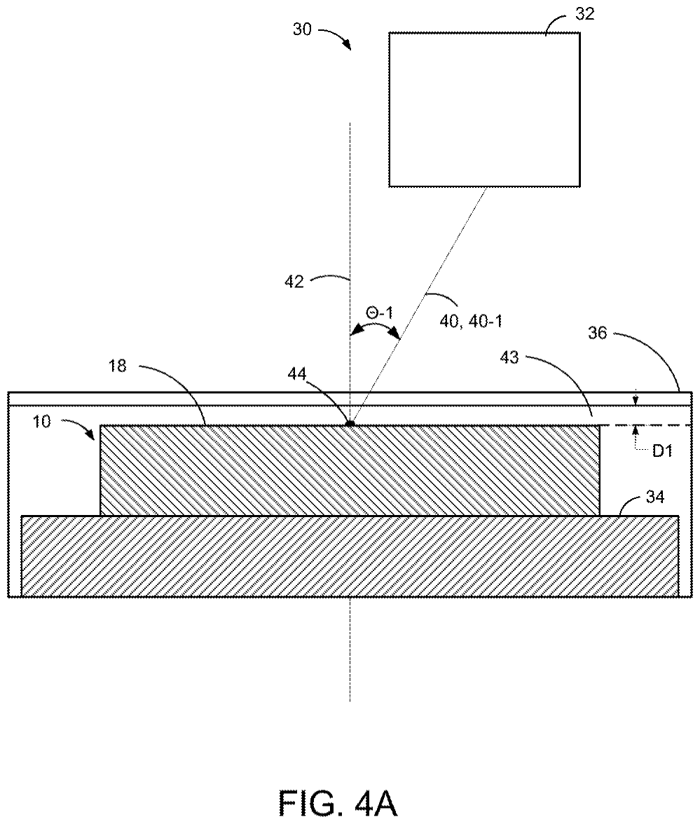

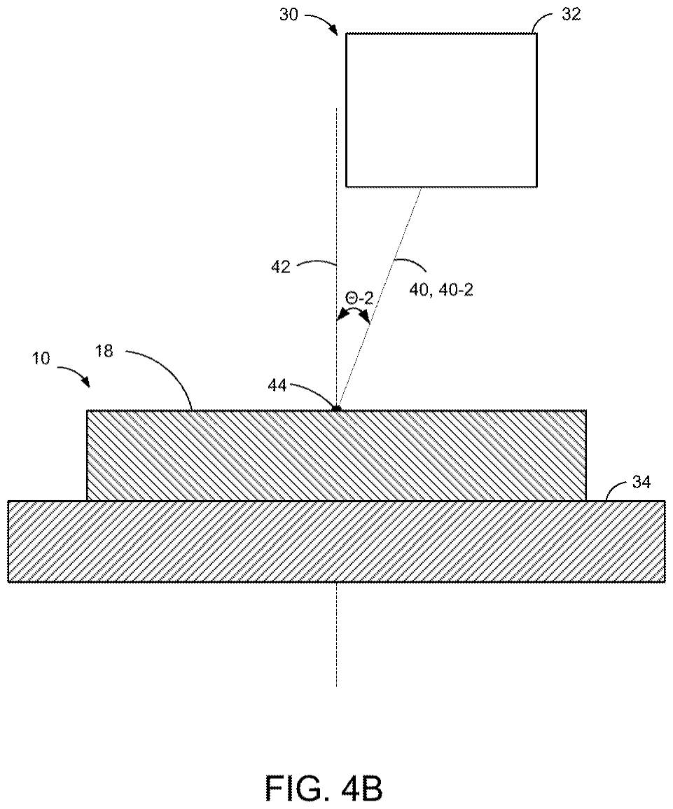

At step 23, the method 20 may include covering a surface (e.g., outermost surface 18) of a component (e.g., component 10) with a medium 43 (FIGS. 3A and 4A). For example, at step 23, the method 20 may include placing the component 10 in the container 36 including the component 10 such that the outermost surface 18 of the component 10 is disposed within the medium 43. The medium 43 may define a depth D1 relative to (e.g., orthogonal to) the outermost surface 18. In some implementations, the depth D1 is less than three hundred micrometers. For example, the depth D1 may be between one hundred and two hundred micrometers.

In some implementations, the medium 43 includes a fluid. For example, the medium 43 may include liquid water or vaporized water. In particular, the medium 43 may include a liquid or vaporized form of de-ionized water, tap water, distilled water, a mixture or solution of water and one or more additives (e.g., salt, colorant, etc.). In some implementations, a vaporized form of the medium 43 includes a vaporized form of water having a high humidity. For example, the vaporized form of the medium 43 may include water having a humidity between ninety percent and ninety-nine percent.

At step 24, the method 20 may include irradiating a component (e.g., component 10) with a laser beam. The laser beam may include the laser beam 40 generated by a laser source (e.g., laser source 32). For example, with reference to FIG. 3A, at step 24, the method 20 may include transmitting a first laser beam 40-1 from the laser source 32, through the medium 43, and to the component 10. In particular, the method 20 may include transmitting the first laser beam 40-1 from the laser source 32, into the container 36 and through the depth D1 of the medium 43, and to the component 10, such that the laser beam 40-1 strikes the outermost surface 18 of the component 10. In some implementations, the layer 14-1, 14-2, . . . 14-n defining the outermost surface 18 of the component 10 includes a microporous nickel material. In this regard, at step 24, the laser beam 40-1 may strike the outermost surface 18 defined by a microporous nickel material. In some implementations, the laser beam 40-1 may include a defocused laser beam. In this regard, the user may adjust the laser source 32 to defocus the laser beam 40-1 by a percentage (e.g., between 0% and 100%) to selectively produce a first color on the outermost surface 18 of the component, such that the outermost surface 18 is primed.

With reference to FIG. 3A, in some implementations, step 24 includes transmitting the laser beam 40-1 at an angle θ-1 relative to a normal 42 of the outermost surface 18. The normal 42 may extend perpendicularly from a location 44 struck by the laser beam 40-1, such that the laser beam 40-1 strikes and marks (e.g., changes the color of) the location 44, while preventing any marking of the remainder of the outermost surface 18. While the location 44 struck by a pulse of the laser beam 40-1 is generally shown and described herein as having a circular shape, it will be appreciated that the location may include, or otherwise define, other shapes within the scope of the present disclosure. For example, in some implementations, a cross-sectional dimension of the laser beam 40-1, or the shape of the location 44 struck by a pulse of the laser beam 40-1 may define an oval shape in order to better control energy density of the laser beam 40-1 and more accurately control the characteristics of the mark created by the laser beam 40-1 at the location 44.

In some implementations, during step 24, at least one of the component 10 or the laser source 32 may move (e.g., translate or rotate) in one or more directions such that the location 44 struck by the laser beam 40-1 changes during step 24. Accordingly, the laser beam 40-1 may create the mark 46 having, or otherwise defined by, a plurality of locations 44 struck by the laser beam 40-1 on the outermost surface 18 through the medium 43. In some implementations, the mark 46 produces, or otherwise defines, a first color (e.g., a light shade of brown or gray) on the outermost surface 18.

During step 24, at least one parameter of the laser source 32 may be selected or varied in order to select or vary a characteristic of the mark 46 created by the laser beam 40-1 at the location(s) 44. For example, in some implementations, a user may select or vary a level of heat input (Joules/mm²) of the laser beam 40-1. In some implementations, a user may select or vary a marking speed (mm/second) of the laser beam 40-1 relative to the component 10. For example, the user may select the velocity at which either the component 10 or the laser source 32 moves (e.g., translates) relative to the other of the component 10 or the laser source 32. In some implementations, the user may select or vary the distance (μm) between adjacent locations 44 struck by the laser beam 40-1. For example, the user may select or vary the distance between a first linear group of locations 44 and a second linear group of locations 44 that is adjacent (e.g., parallel) to the first linear group of locations. In particular, the laser beam 40-1 may create a first portion of the mark 46 defined by a first linear group of locations, and then create a second portion of the mark 46 defined by a second linear group of locations that is adjacent to, and offset from (e.g., in a direction perpendicular to the first or second linear group), the first linear group of locations 44. In some implementations, the user may select or vary a width or duration (nanoseconds) of the pulse of the laser beam 40-1. For example, the user may allow the laser beam 40-1 to strike the location 44 for a predetermined duration. In some implementations, the user may select or vary the average power (Watts) of the laser beam 40-1. In some implementations, the user may select or vary the repetition rate (kHz) of the laser beam 40-1. For example, the user may allow the laser beam 40-1 to pulse a predetermined number of times per second. In some implementations, the user may select or vary the size (μm) of the location 44 struck by the laser beam 40-1. For example, the user may select the diameter or other cross-sectional width of the laser beam 40-1 to select the size of the location 44 contacted by a pulse of the laser beam 40-1. In this regard, by doubling the cross-sectional dimension of the laser beam 40-1, the user may quadruple the area of the location 44, and reduce the intensity of the laser beam 40-1 by seventy-five percent.

As previously described, the laser beam 40-1 may create the mark 46 defining the first color (e.g., a light shade of brown or gray) on the outermost surface 18. In this regard, the appearance of the mark 46 may define the single, first color independent of an angle, orientation, or other characteristic (e.g., lighting) of the environment in which the mark 46 is viewed by an observer. For example, the mark 46 may produce the same, unique visual effect independent of the angle at which it is viewed, the lighting through or under which it is viewed, or the orientation of the mark 46 when it is viewed.

At step 25, the method 20 may include removing the medium 43 from the outermost surface 18 of the component 10. In some implementations, at step 25, the method 20 includes removing the component 10 from the container 36 such that the outermost surface 18 of the component 10 is not covered by the medium 43. In other implementations, at step 25, the method 20 includes removing the medium 43 from the container 36 such that the outermost surface 18 of the component 10 is not covered by the medium 43.

At step 26, the method 20 may include irradiating a component (e.g., component 10) with a laser beam. In some implementations, the laser beam may include the laser beam 40 generated by a laser source (e.g., laser source 32). For example, with reference to FIG. 3B, at step 26, the method 20 may include transmitting a second laser beam 40-2 from the laser source 32 to the component 10. In particular, the method 20 may include transmitting the second laser beam 40-2 from the laser source 32 to the component 10, such that the laser beam 40-2 strikes the outermost surface 18 of the component 10. In this regard, step 26 may be performed in a medium (e.g., ambient air) that is different than the medium 43.

In some implementations, the laser beam 40-2 is a defocused laser beam. In this regard, the user may adjust the laser source 32 to defocus the laser beam 40-2 by a percentage (e.g., between 0% and 100%) to selectively produce a second color on the outermost surface 18 of the component. While the method 20 is generally shown and described herein as including two steps 24, 26, it will be appreciated that the method 20 may include more or less than the two steps 24, 26 within the scope of the present disclosure. For example, the method 20 for laser-marking the component (e.g., component 10) may include multiple (e.g., two or more than two) steps within the scope of the present disclosure. In some implementations, the method 20 for laser-marking the component (e.g., component 10) includes twenty steps.

With reference to FIG. 4B, in some implementations, step 26 includes transmitting the laser beam 40-2 at an angle θ-2 relative to the normal 42 of the outermost surface 18 such that the laser beam 40-2 strikes the location 44 on the outermost surface 18, thus allowing for marking (e.g., coloring) of the location 44 of the outermost surface 18, while preventing any marking of the remainder of the outermost surface 18.

In some implementations, during step 26, at least one of the component 10 or the laser source 32 may move (e.g., translate or rotate) in one or more directions such that the location 44 struck by the laser beam 40-2 changes during step 26. Accordingly, the laser beam 40-2 may create a mark 48 having, or otherwise defined by, a plurality of locations 44 struck by the laser beam 40-2 on the outermost surface 18. The mark 48 may produce, or otherwise define, a second color (e.g., a dark shade of blue) that is different than the first color. In some implementations, the mark 48 is aligned with the mark 46, such that the laser beams 40-1, 40-2 strike at least some of the same plurality of locations 44. In this regard, step 26 may include changing the color of the mark 46 from the first color to the second color.

During step 26, at least one parameter of the laser source 32 may be selected or varied in order to select or vary a characteristic of the mark 48 created by the laser beam 40-2 at the location(s) 44. For example, in some implementations, a user may select or vary a level of heat input (Joules/mm²) of the laser beam 40-2. In some implementations, a user may select or vary a marking speed (mm/second) of the laser beam 40-2 relative to the component 10. For example, the user may select the velocity at which either the component 10 or the laser source 32 moves (e.g., translates) relative to the other of the component 10 or the laser source 32. In some implementations, the user may select or vary the distance (μm) between adjacent locations 44 struck by the laser beam 40-2. For example, the user may select or vary the distance between a first linear group of locations 44 and a second linear group of locations 44 that is adjacent (e.g., parallel) to the first linear group of locations. In particular, the laser beam 40-2 may create a first portion of the mark 48 defined by a first linear group of locations, and then create a second portion of the mark 48 defined by a second linear group of locations that is adjacent to, and offset from (e.g., in a direction perpendicular to the first or second linear group), the first linear group of locations 44.

In some implementations, the user may select or vary a width or duration (nanoseconds) of the pulse of the laser beam 40-2. For example, the user may allow the laser beam 40-2 to strike the location 44 for a predetermined duration. In some implementations, the user may select or vary the average power (Watts) of the laser beam 40-2. In some implementations, the user may select or vary the repetition rate (kHz) of the laser beam 40-2. For example, the user may allow the laser beam 40-2 to pulse a predetermined number of times per second. In some implementations, the user may select or vary the size (μm) of the location 44 struck by the laser beam 40-2. For example, the user may select the diameter or other cross-sectional width of the laser beam 40-2 to select the size of the location 44 contacted by a pulse of the laser beam 40-2. In this regard, by doubling the cross-sectional dimension of the laser beam 40-2, the user may quadruple the area of the location 44, and reduce the intensity of the laser beam 40-2 by seventy-five percent.

In some implementations, the angle θ-2 is different than the angle θ-1. For example, the angle θ-1 may define a first value between zero degrees and eighty-nine degrees, while the angle θ-2 may define a second value, different than the first value, between zero degrees and eighty-nine degrees. In some implementations, the first value of the angle θ-1 is between two degrees and ten degrees different (e.g., less than or greater than) than the second value of the angle θ-2.

As previously described, the laser beam 40-2 may create the mark 48 defining the second color (e.g., a dark shade of blue) on the outermost surface 18. In this regard, the appearance of the mark 48 may define different second colors depending on an angle, orientation, or other characteristic (e.g., lighting) of the environment in which the mark 48 is viewed by an observer. For example, the mark 48 may produce (i) a first unique visual effect (e.g., color) when viewed at a first angle, a first orientation, or under first lighting conditions, and (ii) a second unique visual effect (e.g., color), different than the first unique visual effect, when viewed at a second angle, a second orientation, or under second lighting conditions that is or are different than the first angle, the first orientation, or the first lighting conditions. In this regard, the mark 48 may simultaneously produce the first and second unique and different visual effects when viewed under one or more different conditions (e.g., viewing angle, orientation, lighting conditions, etc.). As previously discussed, while the method 20 is generally shown and described herein as including two steps 24, 26, it will be appreciated that the method 20 may include more or less than the two steps 24, 26 within the scope of the present disclosure. For example, the method 20 for laser-marking the component (e.g., component 10) may include multiple (e.g., two or more than two) steps of marking the surface 18 with a laser beam in order to create marks having a plurality of visual effects within the scope of the present disclosure.

At step 28, the method 20 may include cleaning a component (e.g., the component 10). For example, with reference to FIG. 3C, at step 28, the method 20 may include placing a suitable substance 50 (e.g., water, alcohol (e.g., isopropyl alcohol), etc.) on the outermost surface 18 of the component 10 to remove any soot or other residue created during step 26 or step 28. In particular, the method 20 may include wiping the substance 50 on and over the marks 46, 48 of the outermost surface 18 to remove any residue created by the laser beams 40-1, 40-2 at steps 24, 26.

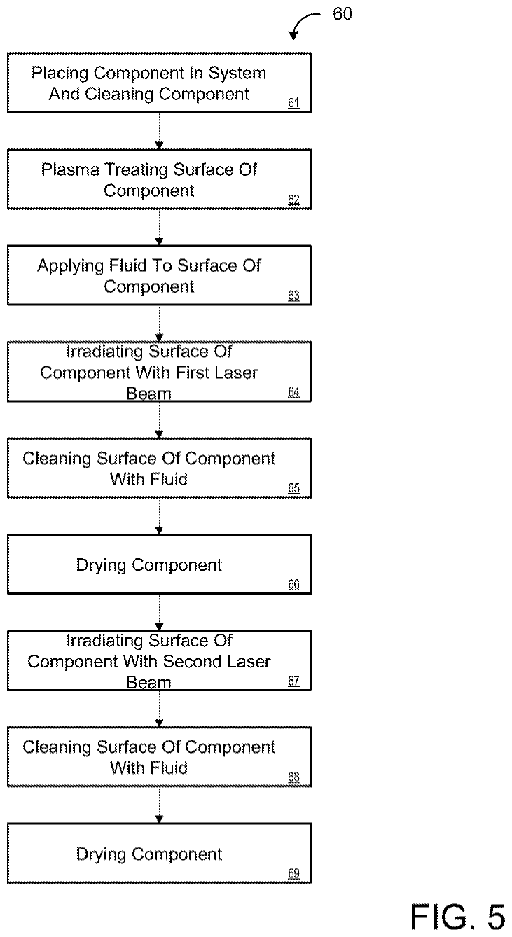

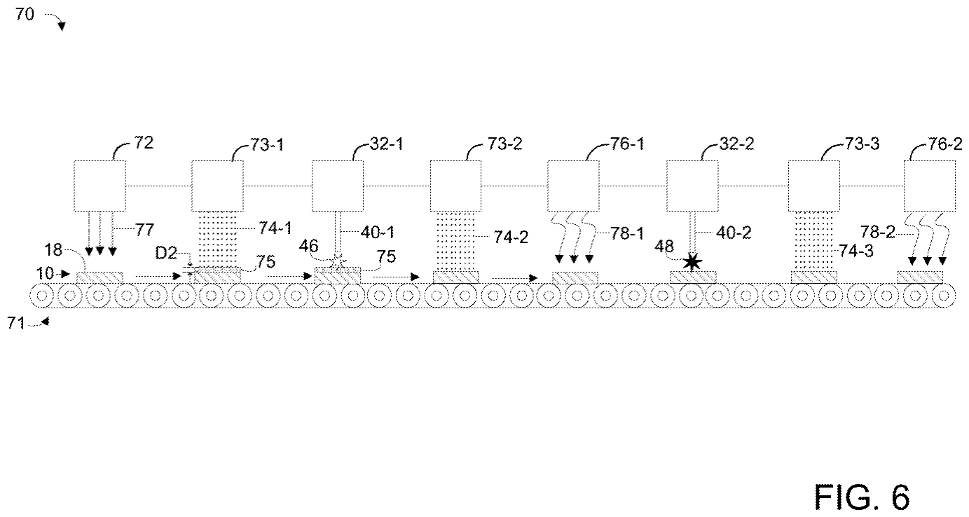

With particular reference to FIGS. 5-8, a method 60 for laser-marking a component (e.g., component 10) is illustrated. As will be described, the method 60 may be implemented using a laser marking system 70 illustrated in FIGS. 6-8. In view of the substantial similarity in function of the components associated with the laser marking system 30 relative to the laser marking system 70, like reference numerals are used hereinafter and in the drawings to identify like components. As will be explained in more detail below, the laser marking system 70 may include a conveyance system 71, plasma spray equipment 72, a first fluid source 73-1, a first laser source 32-1, a second fluid source 73-2, a first dryer 76-1, a second laser source 32-2, a third fluid source 73-3, and a second dryer 76-2.

As illustrated in FIG. 5, at step 61, the method may include placing a component (e.g., component 10) in a laser marking system (e.g., laser marking system 70). For example, with reference to FIG. 6, at step 61, the method 70 may include placing the component 10 on the conveyance system 71. The conveyance system 71 may be configured to transport the component 10 in a continuous manner to allow the component 10 to undergo various steps of the laser-marking method 60, as will be described in more detail below. For example, in some implementations, the conveyance system 71 may transport the component 10 in order to subject the outermost surface 18 of the component 10 to a plasma spray 77, a first fluid 74-1, a first laser beam 40-1, a second fluid 74-2, a first dryer fluid 78-1, a second laser beam 40-2, a third fluid 73-3, and a second dryer fluid 78-2.

In some implementations, the conveyance system 71 includes at least one of a belt assembly, a continuous loop of a carrying medium, or a plurality of rollers. In some examples, prior to or after placing the component 10 on the conveyance system 71, step 61 may further include inspecting and/or cleaning the component 10. For example, step 61 may include removing contaminants including dust, finger prints, and oil reside from a surface (e.g., surface 18) of the component 10.

In some configurations, in lieu of a conveyance system 71, the component 10 may remain stationary and the plasma spray equipment 72, the first fluid source 73-1, the first laser source 32-1, the second fluid source 73-2, the first dryer 76-1, the second laser source 32-2, the third fluid source 73-3, and the second dry 76-2 may be configured to move in a continuous fashion in order to subject the outermost surface 18 of the component 10 to the plasma spray 77, the first fluid 74-1, the first laser beam 40-1, the second fluid 74-2, the first dryer fluid 78-1, the second laser beam 40-2, the third fluid 73-3, and the second dryer fluid 78-2.

At step 62, the method 60 may include plasma treating a surface (e.g., outermost surface 18) of a component (e.g., component 10). For example, with reference to FIG. 6, the plasma spray equipment 72 may expel a plasma spray 77 onto the component 10. The plasma spray 77 may etch the outermost surface 18 of the component 10 in order to create a hydrophilic surface. In some implementations, the outermost surface 18 of the component 10 may be subjected to a plasma spray 77 for a period of time between approximately 20 seconds and 60 seconds.

At step 63, the method 60 may include applying a first fluid 74-1 to a surface (e.g., outermost surface 18) of a component (e.g., component 10). For example, step 63 may include covering the outermost surface 18 of the component 10 with the first fluid 74-1. The first fluid 74-1 may include a liquid or vaporized form of de-ionized water, tap water, distilled water, or a mixture or solution of water and one or more additives (e.g., salt, colorant, etc.). With reference to FIG. 6, in some implementations, the first fluid source 73-1 may spray the first fluid 74-1 onto the outermost surface 18 of the component 10. The first fluid 74-1 may be applied evenly to form a layer 75 of the first fluid 74-1 on the outermost surface 18 of the component 10. In some examples, the layer 75 defines a depth D2 relative to (e.g., orthogonal to) the outmost surface 18. In some implementations, the depth D2 is less than three hundred micrometers. For example, the depth D2 may be between one hundred and two hundred micrometers.

At step 64, the method 60 may include irradiating a component (e.g., 10) with a laser beam (e.g., laser beam 40). For example, with reference to FIG. 6, the laser beam 40 may be generated by a laser source (e.g., laser source 32) in the manner previously described. In particular, the method 60 may include transmitting a first laser beam 40-1, from a first laser source 32-1, through the first fluid medium 75, and to the component 10. In some implementations, the method 60 includes transmitting the laser beam 40-1 from the laser source 32-1, through the depth D2 of the first fluid medium 75, and to the component 10, such that the laser beam 40-1 strikes the outermost surface 18 of the component 10. The laser beam 40-1 may include a defocused laser beam. In this regard, the user may adjust the laser source 32-1 to defocus the laser beam 40-1 by a percentage (e.g., between 0% and 100%) to selectively produce a first color and/or a first pattern on the outermost surface 18 of the component 10.

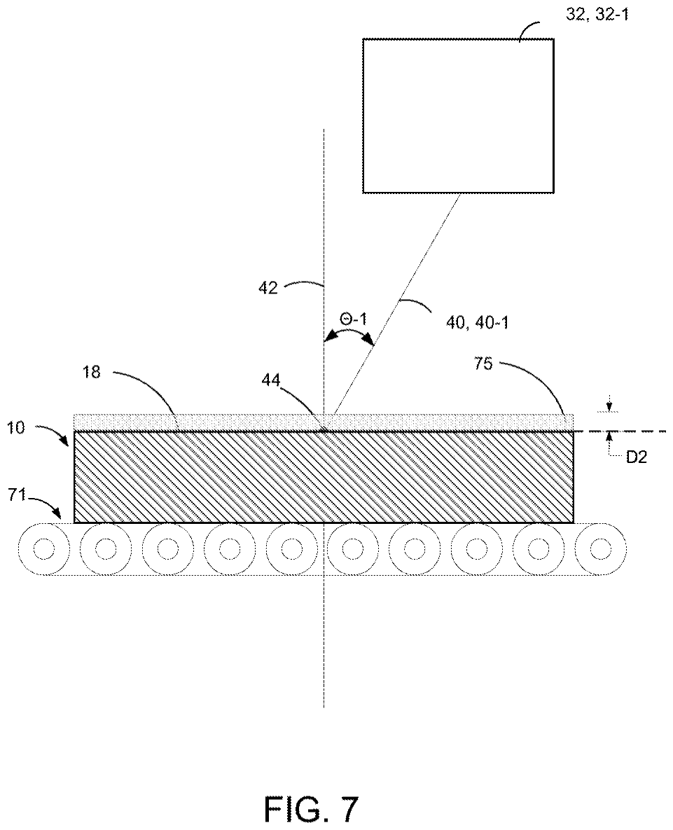

With reference to FIG. 7, in some implementations, step 64 includes transmitting the laser beam 40-1 at an angle (e.g., angle θ-1) relative to the normal 42 of the outermost surface 18. The normal 42 may extend perpendicularly from a location (e.g., location 44) struck by the laser beam 40-1, such that the laser beam 40-1 strikes and marks (e.g., changes the color of) the location 44, while preventing any marking of the remainder of the outermost surface 18.

During step 64, at least one parameter of the laser source 32-1 may be selected or varied in order to select or vary a characteristic of the mark 46 created by the laser beam 40-1 at the location(s) 44. For example, in some implementations, a user may select or vary a level of heat input (Joules/mm²) of the laser beam 40-1. In some implementations, a user may select or vary a marking speed (mm/second) of the laser beam 40-1 relative to the component 10. For example, the user may select the velocity at which either the component 10 or the laser source 32-1 moves (e.g., translates) relative to the other of the component 10 or the laser source 32-1. In some implementations, the user may select or vary the distance (μm) between adjacent locations 44 struck by the laser beam 40-1. For example, the user may select or vary the distance between a first linear group of locations 44 and a second linear group of locations 44 that is adjacent (e.g., parallel) to the first linear group of locations. In particular, the laser beam 40-1 may create a first portion of the mark 46 defined by a first linear group of locations 44, and then create a second portion of the mark 46 defined by a second linear group of locations 44 that is adjacent to, and offset from (e.g., in a direction perpendicular to the first or second linear group), the first linear group of locations 44. In some implementations, the user may select or vary a width or duration of the pulse of the laser beam 40-1. For example, the user may allow the laser beam 40-1 to strike the location 44 for a predetermined amount of time. In some implementations, the user may select or vary the average power (Watts) of the laser beam 40-1. In some implementations, the user may select or vary the frequency (kHz) of the laser beam 40-1. For example, the user may allow the laser beam 40-1 to pulse a predetermined number of times per second. In some implementations, the user may select or vary the size of the location 44 struck by the laser beam 40-1. For example, the user may select the diameter or other cross-sectional width of the laser beam 40-1 to select the size of the location 44 contacted by a pulse of the laser beam 40-1. In this regard, by doubling the cross-sectional dimension of the laser beam 40-1, the user may quadruple the area of the location 44, and proportionally reduce the intensity of the laser beam 40-1.

As previously described, the laser beam 40-1 may create the mark 46 defining the first color (e.g., a light shade of brown or gray) and/or a first pattern on the outermost surface 18. In this regard, the appearance of the mark 46 may define the single, first color independent of an angle, orientation, or other characteristic (e.g., lighting) of the environment in which the mark 46 is viewed by an observer. For example, the mark 46 may produce the same, unique visual effect independent of the angle at which it is viewed, the lighting through or under which it is viewed, or the orientation of the mark 46 when it is viewed.

At step 65, the method 60 may include cleaning a surface (e.g., outermost surface 18) of a component (e.g., component 10) with the second fluid 74-2. The second fluid 74-2 may include a liquid or vaporized form of de-ionized water, tap water, distilled water, or a mixture or solution of water and one or more additives (e.g., salt, colorant, etc.). With reference to FIG. 6, in some implementations, the second fluid source 73-2 sprays the second fluid 74-2 onto the surface 18 of the component 10. The second fluid 74-2 may remove soot or other reside from the component created by the laser beam 40-1 at step 64.

At step 66, the method 60 may include drying a surface (e.g., surface 18) of a component (e.g., component 10). For example, at step 66, a first dryer 76-1 may apply a first dryer fluid 78-1 to the surface 18 of the component 10. In particular, with reference to FIG. 6, in some implementations, the dryer 76-1 may apply air to the surface 18 of the component 10 at step 66. In some implementations, the dryer 76-1 includes a high pressure de-static air dryer applying high pressure de-static air onto the surface 18 at step 66.

At step 67, the method 60 may include irradiating a component (e.g., component 10) with a laser beam. In some implementations, the laser beam may include the laser beam 40 generated by a laser source (e.g., laser source 32). For example, with reference to FIG. 6, at step 67, the method 60 may include transmitting a second laser beam 40-2 from a second laser source 32-2 to the component 10. In particular, the method 60 may include transmitting the second laser beam 40-2 from the laser source 32-2 to the component 10, such that the laser beam 40-2 strikes the outermost surface 18 of the component 10. In this regard, step 67 may be performed in a medium (e.g., ambient air) that is different than the layer 75 of the first fluid 74-1. In some implementations, the laser beam 40-2 is a defocused laser beam. In this regard, the user may adjust the laser source 32-2 to defocus the laser beam 40-2 by a percentage (e.g., between 0% and 100%) to selectively produce a second color on the outermost surface 18 of the component.

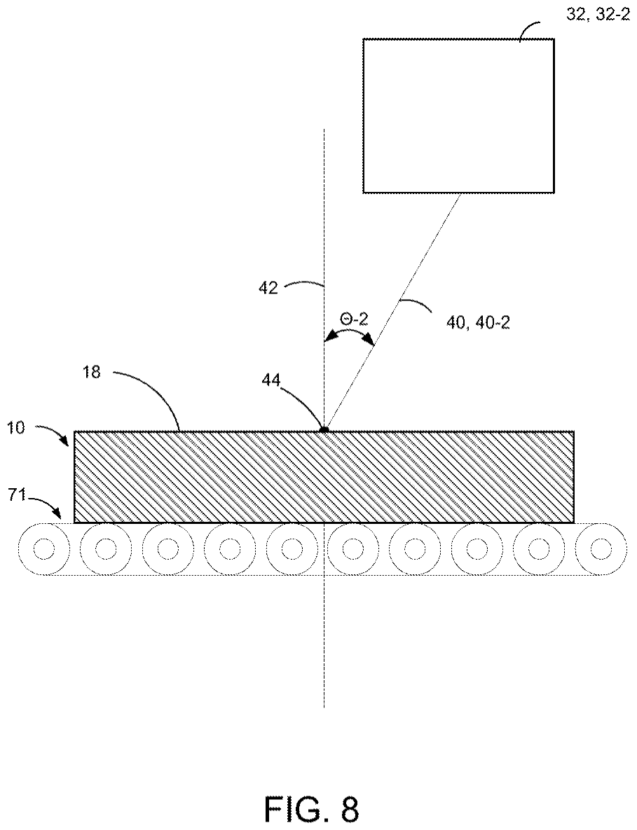

With reference to FIG. 8, in some implementations, step 67 includes transmitting the laser beam 40-2 at an angle θ-2 relative to the normal 42 of the outermost surface 18 such that the laser beam 40-2 strikes the location 44 on the outermost surface 18, thus allowing for marking (e.g., coloring) of the location 44 of the outermost surface 18, while preventing any marking of the remainder of the outermost surface 18.

In some implementations, during step 67, the laser beam 40-2 may create a mark 48 having, or otherwise defined by, a plurality of locations 44 struck by the laser beam 40-2 on the outermost surface 18. The mark 48 may produce, or otherwise define, a second color (e.g., a dark shade of blue) that is different than the first color. In some implementations, the mark 48 is aligned with the mark 46, such that the laser beams 40-1, 40-2 strike at least some of the same plurality of locations 44. In this regard, step 67 may include changing the color of the mark 46 from the first color to the second color.

During step 67, at least one parameter of the laser source 32-2 may be selected or varied in order to select or vary a characteristic of the mark 48 created by the laser beam 40-2 at the location(s) 44. For example, in some implementations, a user may select or vary a level of heat input (Joules/mm²) of the laser beam 40-2. In some implementations, a user may select or vary a marking speed (mm/second) of the laser beam 40-2 relative to the component 10. For example, the user may select the velocity at which either the component 10 or the laser source 32-2 moves (e.g., translates) relative to the other of the component 10 or the laser source 32-2. In some implementations, the user may select or vary the distance (μm) between adjacent locations 44 struck by the laser beam 40-2. For example, the user may select or vary the distance between a first linear group of locations 44 and a second linear group of locations 44 that is adjacent (e.g., parallel) to the first linear group of locations. In particular, the laser beam 40-2 may create a first portion of the mark 48 defined by a first linear group of locations, and then create a second portion of the mark 48 defined by a second linear group of locations that is adjacent to, and offset from (e.g., in a direction perpendicular to the first or second linear group), the first linear group of locations 44.

In some implementations, the user may select or vary a width or duration of the pulse of the laser beam 40-2. For example, the user may allow the laser beam 40-2 to strike the location 44 for a predetermined duration. In some implementations, the user may select or vary the average power (Watts) of the laser beam 40-2. In some implementations, the user may select or vary the frequency (kHz) of the laser beam 40-2. For example, the user may allow the laser beam 40-2 to pulse a predetermined number of times per second. In some implementations, the user may select or vary the size (μm) of the location 44 struck by the laser beam 40-2. For example, the user may select the diameter or other cross-sectional width of the laser beam 40-2 to select the size of the location 44 contacted by a pulse of the laser beam 40-2. In this regard, by doubling the cross-sectional dimension of the laser beam 40-2, the user may quadruple the area of the location 44, and proportionally reduce the intensity of the laser beam 40-2.

In some implementations, the angle θ-2 is different than the angle θ-1. For example, the angle θ-1 may define a first value between zero degrees and eighty-nine degrees, while the angle θ-2 may define a second value, different than the first value, between zero degrees and eighty-nine degrees. In some implementations, the first value of the angle θ-1 is between two degrees and ten degrees different (e.g., less than or greater than) than the second value of the angle θ-2.

As previously described, the laser beam 40-2 may create the mark 48 defining the second color (e.g., a dark shade of blue) and/or a second pattern on the outermost surface 18. In this regard, the appearance of the mark 48 may define different second colors depending on an angle, orientation, or other characteristic (e.g., lighting) of the environment in which the mark 48 is viewed by an observer. For example, the mark 48 may produce (i) a first unique visual effect (e.g., color) when viewed at a first angle, a first orientation, or under first lighting conditions, and (ii) a second unique visual effect (e.g., color), different than the first unique visual effect, when viewed at a second angle, a second orientation, or under second lighting conditions that is or are different than the first angle, the first orientation, or the first lighting conditions. In this regard, the mark 48 may simultaneously produce the first and second unique and different visual effects when viewed under one or more different conditions (e.g., viewing angle, orientation, lighting conditions, etc.).

At step 68, the method 60 may include cleaning a surface (e.g., outermost surface 18) of a component (e.g., component 10) with the third fluid 74-3. The third fluid 74-3 may include a liquid or vaporized form of de-ionized water, tap water, distilled water, or a mixture or solution of water and one or more additives (e.g., salt, colorant, etc.). With reference to FIG. 6, in some implementations, the third fluid source 73-3 sprays the third fluid 74-3 onto the surface 18 of the component 10. The third fluid 74-3 may remove soot or other reside from the component created by the laser beam 40-2 at step 67.

At step 69, the method 60 may include drying a surface (e.g., surface 18) of a component (e.g., component 10). For example, at step 69, a second dryer 76-2 may apply a second dryer fluid 78-2 to the surface 18 of the component 10. In particular, with reference to FIG. 6, in some implementations, the dryer 76-2 may apply air to the surface 18 of the component 10 at step 69. In some implementations, the dryer 76-2 includes a high pressure de-static air dryer applying high pressure de-static air onto the surface 18 at step 67.

While the method 60 is generally shown and described herein as including multiple steps 64, 67 of irradiating a surface (e.g., surface 18) of a component (e.g., component 10) with a laser beam (e.g., 40), multiple steps 65, 68 of cleaning the surface of the component with a fluid (e.g., 74), and multiple steps 66, 69 of drying the component, it will be appreciated that the method 60 may include more or less than the foregoing steps within the scope of the present disclosure. For example, the method 60 for laser-marking the component (e.g., component 10) may include a single step of irradiating the surface of the component with the laser beam, cleaning the surface of the component with fluid, and drying the component within the scope of the present disclosure. In some implementations, the method 60 for laser-marking the component (e.g., component 10) includes twenty steps.

The systems (e.g., system 30, 70) and methods (e.g., method 20, 60) illustrated and described in this disclosure can produce a finished component 10 that exhibits improved properties and characteristics. For example, the component 10 treated by the systems (e.g., system 30, 70) and methods (e.g., method 20, 60) illustrated and described in this disclosure can produce a finished component 10 that resists leaching of one or more materials. In particular, the component 10 treated by the systems (e.g., system 30, 70) and methods (e.g., method 20, 60) illustrated and described in this disclosure can produce a finished component 10 that (i) exhibits low stress (e.g., few or no micro-cracks) and/or high gloss (e.g., high specular reflection) and/or (ii) does not leach chromium-3 or chromium-6.

The following Clauses provide an exemplary configuration of a method of marking a location on a surface of a component, as described above.

Clause 1: A method of marking a location on a surface of a component, the location defining a normal extending perpendicularly therefrom, the method comprising: covering the surface of the component with a first medium; irradiating the location with a first laser beam through the first medium to create a first mark having a first color; and removing the first medium from the surface of the component.

Clause 2: The method of Clause 1, wherein the first medium includes at least one of de-ionized water, tap water, distilled water, or a mixture of water and at least one of a salt or a colorant.

Clause 3: The method of Clause 2, wherein the first medium is in a vaporized form defining a humidity between ninety percent and ninety-nine percent.

Clause 4: The method of any one of Clauses 1-3, wherein the first medium defines a depth between one hundred and two hundred micrometers.

Clause 5: The method of any one of Clauses 1-4, further comprising irradiating the location with a second laser beam to create a second mark having a second color different than the first color prior to removing the first medium from the surface of the component.

Clause 6: The method of Clause 5, wherein the first laser beam disposed at a first angle relative to the normal, and the second laser beam disposed at a second angle relative to the normal, the second angle being different than the first angle.

Clause 7: The method of Clause 6, wherein the first angle is greater than the second angle.

Clause 8: The method of Clause 6, wherein the first angle is less than the second angle.

Clause 9: The method of any one of Clauses 1-8, further comprising plasma treating the surface of the component prior to covering the surface of the component with the first medium.

Clause 10: The method of any one of Clauses 1-9, further comprising cleaning the surface of the component with de-ionized water after irradiating the location with the first laser beam.

Clause 11: The method of any one of Clauses 1-10, further comprising drying the component.

Clause 12: The method of any one of Clauses 1-11, wherein the first laser beam is generated by a laser source, the method further comprising moving one of the component or the laser source relative to another of the component or the laser source while irradiating the location with the first laser beam.

Clause 13: The method of Clause 5, further comprising moving one of the component or the laser source relative to the other of the component or the laser source while irradiating the location with the second laser beam.

Clause 14: The method of Clause 5, wherein the first color includes a shade of gray or a shade of brown, and the second color includes a shade of blue.

Clause 15: The method of any one of Clauses 1-14, further comprising defocusing the first laser beam.

Clause 16: The method of Clause 5, further comprising removing a residue from the second mark.

Clause 17: The method of Clause 16, wherein removing the residue from the second mark includes applying alcohol or water to the surface.

Clause 18: The method of any one of Clauses 1-17, wherein the surface is formed at least in part from chrome.

Clause 19: The method of any one of Clauses 1-18, further comprising covering the surface with a second medium.

Clause 20: The method of Clause 19, wherein the second medium includes ambient air.

Clause 21: A method of laser marking comprising: providing a component comprising an outer surface including a location having a first color; covering the outer surface with a first medium; irradiating the location through the first medium with a first laser beam to change the first color of the location to a second color; and removing the component from the first medium.

Clause 22: The method of Clause 21, wherein the first medium includes at least one of de-ionized water, tap water, distilled water, or a mixture of water and at least one of a salt or a colorant.

Clause 23: The method of Clause 21, wherein the first medium is in a vaporized form defining a humidity between ninety percent and ninety-nine percent.

Clause 24: The method of Clause 21, wherein the first medium defines a depth between one hundred and two hundred micrometers.

Clause 25: The method of Clause 21, further comprising irradiating the location with a second laser beam to change the second color of the location to a third color prior to removing the first medium from the surface of the component.

Clause 26: The method of Clause 25, wherein the first laser beam disposed at a first angle relative to a normal extending from the location, and the second laser beam disposed at a second angle relative to the normal, the second angle being different than the first angle.

Clause 27: The method of Clause 26, wherein the first angle is greater than the second angle.

Clause 28: The method of one of Clauses 26 or 27, wherein the first angle is less than the second angle.

Clause 29: The method of any one of Clauses 21-28, further comprising plasma treating the surface of the component prior to covering the surface of the component with the first medium.

Clause 30: The method of any one of Clauses 21-29, further comprising cleaning the surface of the component with de-ionized water after irradiating the location with the first laser beam.

Clause 31: The method of any one of Clauses 21-30, further comprising drying the component.

Clause 32: The method of any one of Clauses 21-31, wherein the first laser beam is generated by a laser source, the method further comprising moving one of the component or the laser source relative to another of the component or the laser source while irradiating the location with the first laser beam.

Clause 33: The method of Clause 25, further comprising moving one of the component or the laser source relative to the other of the component or the laser source while irradiating the location with the second laser beam.

Clause 34: The method of any one of Clauses 21-33, wherein the second color includes a shade of gray or a shade of brown, and the third color includes a shade of blue.

Clause 35: The method of any one of Clauses 21-34, further comprising defocusing the first laser beam.

Clause 36: The method of any one of Clauses 21-35, further comprising removing a residue from the location.

Clause 37: The method of claim 36, wherein removing the residue from the location includes applying alcohol or water to the outer surface.

Clause 38: The method of any one of Clauses 21-37, wherein the outer surface is formed at least in part from chrome.

Clause 39: The method of any one of Clauses 21-38, further comprising covering the outer surface with a second medium.

Clause 40: The method of Clause 39, wherein the second medium includes ambient air.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of marking a location on a surface of a component, the location defining a normal extending perpendicularly therefrom, the method comprising:
covering the surface of the component with a first medium;
irradiating the location with a first laser beam through the first medium to create a first mark having a first color; and
removing the first medium from the surface of the component.

2. The method of claim 1, wherein the first medium includes at least one of de-ionized water, tap water, distilled water, or a mixture of water and at least one of a salt or a colorant.

3. The method of claim 1, wherein the first medium defines a depth between one hundred and two hundred micrometers.

4. The method of claim 1, further comprising irradiating the location with a second laser beam to create a second mark having a second color different than the first color prior to removing the first medium from the surface of the component.

5. The method of claim 4, further comprising removing a residue from the second mark.

6. The method of claim 1, further comprising plasma treating the surface of the component prior to covering the surface of the component with the first medium.

7. The method of claim 1, wherein the first laser beam is generated by a laser source, the method further comprising moving one of the component or the laser source relative to another of the component or the laser source while irradiating the location with the first laser beam.

8. The method of claim 1, wherein the surface is formed at least in part from chrome.

9. The method of claim 1, further comprising covering the surface with a second medium.

10. The method of claim 9, wherein the second medium includes ambient air.

11. A method of laser marking comprising:
providing a component comprising an outer surface including a location having a first color;
covering the outer surface with a first medium;
irradiating the location through the first medium with a first laser beam to change the first color of the location to a second color; and
removing the component from the first medium.

12. The method of claim 11, wherein the first medium includes at least one of de-ionized water, tap water, distilled water, or a mixture of water and at least one of a salt or a colorant.

13. The method of claim 11, wherein the first medium defines a depth between one hundred and two hundred micrometers.

14. The method of claim 11, further comprising irradiating the location with a second laser beam to change the second color of the location to a third color prior to removing the first medium from the outer surface of the component.

15. The method of claim 14, further comprising removing a residue from the location.

16. The method of claim 11, further comprising plasma treating the outer surface of the component prior to covering the outer surface of the component with the first medium.

17. The method of claim 11, wherein the first laser beam is generated by a laser source, the method further comprising moving one of the component or the laser source relative to another of the component or the laser source while irradiating the location with the first laser beam.

18. The method of claim 11, wherein the outer surface is formed at least in part from chrome.

19. The method of claim 11, further comprising covering the outer surface with a second medium.

20. The method of claim 19, wherein the second medium includes ambient air.
